(19) United States
(12) Patent Application Publication
(10) Pub. No.: US 2002/0053612 A1
(43) Pub. Date: May 9, 2002

(54) LOW VELOCITY CONCRETE PUMPING ADAPTER

(76) Inventor: STEPHEN F. TANSOSCH, WURTSBORO, NY (US)

Correspondence Address: Patterson Belknap Webb & Tyler, LLP, Attention: I.P. Docketing, 1133 Avenue of the Americas, New York, NY, 10036, US

(21) Appl. No.: 09/400,932

(22) Filed: Sep. 22, 1999

(51) Int. Cl. B67B 7/00

(52) U.S. Cl. 239/542

(57) ABSTRACT

A low velocity concrete pumping adapter which enables a substantially splatter-free, controlled pour from a boom is provided. The adapter comprises collars which surround and position a discharge hose to achieve a substantially “J” or “C” shaped bend in the hose relatively near the point of discharge. The collars are connected by a linkage by which the angle or bend in the discharge hose may be controlled such that the pour of the concrete may be controlled.

### BACKGROUND OF THE INVENTION

The present invention relates to velocity controlling pumping hose adapters and, more specifically, pumping hose adapters which are particularly useful to control the velocity of concrete pumped from a truck via a boom.

As experienced concrete pump operators know, pumping concrete requires great skill. Smooth and successful concrete pumping is not just pushing a button or flipping a switch, but requires a high degree of attentiveness to the concrete truck discharging a load of concrete into the pump truck hopper, to the pump truck itself, to the boom, and to the discharge hose which directs the concrete into the desired form or shape.

Most experienced concrete pump operators know that when concrete is pumped horizontally, e.g., a “line pour” where hoses and/or pipes are placed on the floor, the concrete placement is very smooth and can be done slowly and splatter-free. But, when the operator places concrete using a “boom pour,” where the discharge hose is suspended vertically or at an angle having a vertical component, to have a successful splatter-free placement the operator has to pump the concrete at a rapid rate of speed or volume.

There are job conditions, however, where low-volume, low-velocity concrete placement is required. These conditions include: filling holes in concrete blocks, filling Styrofoam concrete form foundations, pouring sidewalks (especially around pools), and preparing footings. Of course, there are innumerable other job conditions where it would be ideal to have a slow, smooth and splatter-free concrete placement which will be apparent to anyone in the industry. Desired volumetric flows of concrete range between the order of approximately ⅛ to ¾ ft.³/sec.

There have been several attempts to develop inventions for placing concrete at low velocity. These include nozzles, pin pours, and rigid single-angle elbows attached to the end of the discharge hose. However, none of those attempts have resulted in a substantially splatter-free, controlled pour.

The present invention overcomes this problem in the prior art by use of an adapter which strategically introduces a bend in the discharge hose such that it roughly resembles the shape of a “J” or “C” or a variety of other shapes. By doing this, the end of the discharge hose stays in the desired position while it is still suspended proximate to the boom. Introducing this bend effectively re-creates line pour conditions in a freely suspended discharge hose being used for a boom pour.

### SUMMARY OF THE INVENTION

The present invention describes a low velocity pumping adapter to discharge concrete in a substantially splatter-free manner. More particularly, the present invention may be utilized in conjunction with a concrete pumping truck having an open-ended boom. The present invention comprises at least one collar having an inner surface for contacting at least a portion of the circumference of a discharge hose and a linkage connected to the at least one collar for enabling the discharge hose to move through a range of angles. The discharge hose has an input end and an output end, and the adapter is capable of positioning the output end of the discharge hose.

The range of movement of the discharge hose typically is between approximately 0° and approximately 180° from vertical, but other ranges are possible.

The adapter preferably comprises additional collars connected to the linkage by a flanges secured thereon. The additional collars would also be positioned around at least a portion of the circumference of the discharge hose. Moreover, at least one of the collars would be connected by the linkage to at least one of the other collars. The linkage may comprise a chain, rigid or semi-rigid member, or a combination of both.

Thus, it is an object of the present invention to provide an adapter which enables substantially splatter-free, smooth, controlled concrete pour from a boom.

It is a further object of the present invention to provide an adapter which is easily and inexpensively manufactured, and which is easily assembled and disassembled.

It is yet a further object of the present invention to provide an adapter which is easily used and implemented to achieve a substantially splatter-free, smooth, controlled pour from a boom.

It is yet a further object of the present invention to provide an adapter which enables the safe and efficient substantially splatter-free, smooth, controlled pour of concrete from a boom.

It is yet a further object of the present invention to provide a method for discharging concrete in a substantially splatter-free manner.

Additional objects and features of the present invention will become apparent from the following detailed description in which the preferred embodiment is set forth in conjunction with the accompanying drawings, in which:

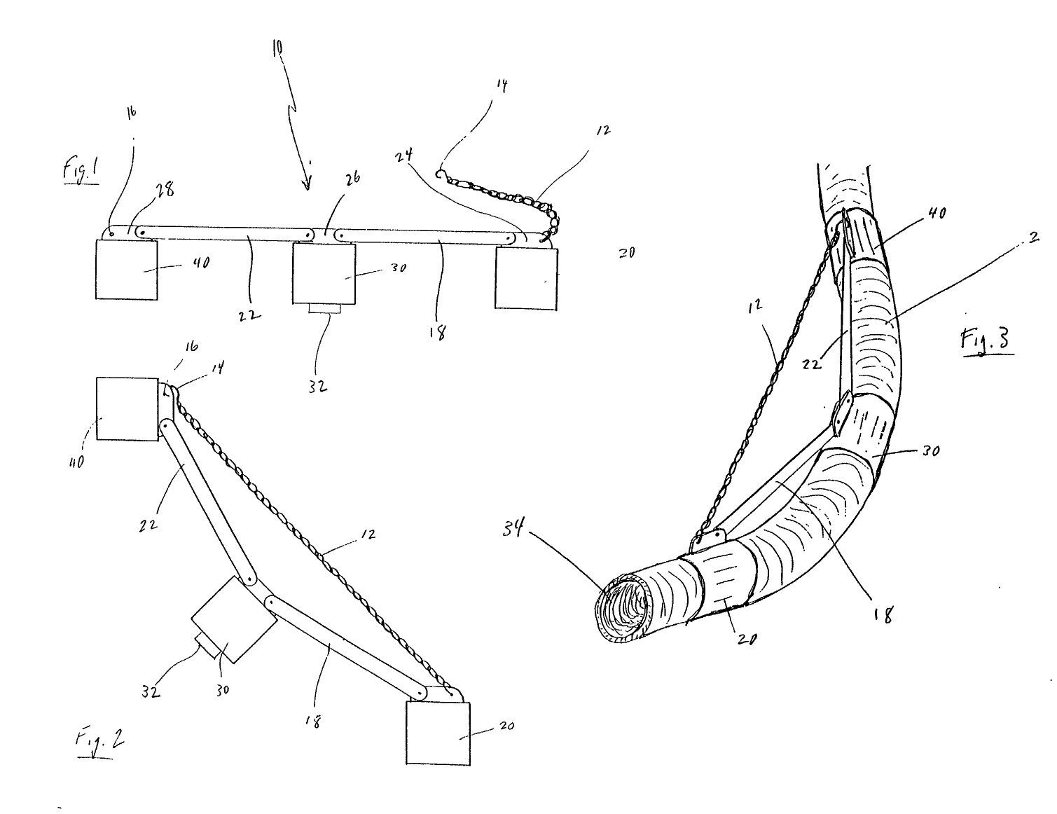

FIG. 1 is a side view of a low velocity concrete pumping adapter in accordance with the present invention;

FIG. 2 is a side view of a low velocity concrete pumping adapter in accordance with the present invention; and

FIG. 3 is a perspective view of a low velocity concrete pumping adapter in accordance with the present invention, shown in conjunction with a discharge hose.

### DETAILED DESCRIPTION OF AN EMBODIMENT OF THE INVENTION

In FIG. 1, a low velocity concrete pumping adapter 10 in accordance with the preferred embodiment is shown. Adapter 10 has at least one collar 20, but preferably also has collars 30 and 40, as shown. Collars 20 and 30 each have a respective flange portion 24, 26 connected thereon or, alternatively, secured thereto. As shown, link 18 is positioned between and connects collars 20 and 30 via flanges 24, 26. Similarly, linkage 22 is positioned between and connects collars 30 and 40 via flanges 26, 28.

Linkages 18 and 22 are preferably in the form of rigid or semi-rigid members, but may take any other suitable form with varying degrees of resiliency. Collars 20, 30 and 40 are preferably of sufficient rigidity to at least withstand forces exerted thereupon by discharge hose 2. For ease of reference, the “mid-collar”—collar 30—is shown as a collar which fully encircles the discharge hose 2; however, it will be appreciated that none of the collars need completely to encircle the discharge hose 2 so long as each collar serves the role of shaping and/or bending the discharge hose 2 to achieve the desired bend or angle. Preferably, collar 30 has handle 32 thereon to promote the safe and efficient operation of the adapter.

Linkage 12 connects collar 20 to collar 40 via flanges 24, 28, as shown. Linkage 12 is preferably in the form of rigid or semi-rigid member, but also may take any other suitable form with varying degrees of resiliency; linkage 12 may be a rope, cord, chain, or adjustable hard bar, for instance. One end of linkage 12 is secured to flange 24, while the other end of link 12 is removably secured to flange 28. The removable end of link 12 is shown with means 14 which, as shown in FIG. 2, can be placed into hole 16 in order to removably secure link 12 to flange 28.

As seen in FIG. 3, discharge hose 2 has output end 34. Collars 20, 30 and 40 are placed around the circumference of discharge hose 2. Thus, collars 20, 30 and 40 preferably have a cross-section which can accommodate the discharge hose.

In operation, the discharge hose 2 is placed through collars of adapter 10. As shown, the adapter is placed near discharge end 34 of the discharge hose 2. The pump operator, however, will need to determine optimal placement based upon conditions and materials, but placement near the discharge end is preferred. The concrete pump operator will, in his or her best professional judgment, determine the optimal pouring angle for the particular concrete pumping job, and then adjust the linkage 12, in conjunction with linkages 18, 22 which freely pivot about points on flanges 24, 26 and 28 respectively on collars 20, 30 and 40, to achieve that bend or angle. After the angle had been determined and the linkage set, it is possible that conditions may change. Accordingly, the concrete pump operator should monitor the delivery of concrete to ensure the continued substantially splatter-free delivery of concrete. If the situation warrants, i.e., the delivery of concrete is no longer substantially splatter-free, then the operator may adjust the linkage to form a different bend in the discharge hose to maintain a controlled, substantially splatter-free delivery.

The adapter described herein can achieve angles between approximately 0° and approximately 180° from vertical. This newly created curved shape or angle allows for smooth, low volume, substantially splatter-free concrete placement.

Adapter 10 is easy to manufacture, can be made to install in seconds, and allows the concrete pump operator the freedom and maneuverability of a suspended concrete hose proximate to the boom tip. Also, most importantly, it allows the operator to pump and place the concrete slowly, smoothly and virtually splatter-free. This adapter need not be a separate slip on attachment but, e.g., can also be connectable to, connected to, affixed to, or formed within the discharge hose 2 or end-piece for a discharge hose.

While the invention has been described in connection with the preferred embodiment, it is to be understood that it is not intended to limit the invention to that embodiment. To the contrary, it is intended to cover all alternatives, modifications and equivalents as may be included within the spirit and scope of the invention as defined by the appended claims.

I claim:

1. A low velocity pumping adapter to discharge concrete in a substantially splatter-free manner for use with a concrete pumping truck with an open-ended boom, said adapter comprising:
at least one collar having an inner surface for contacting at least a portion of the circumference of a discharge hose; and
a linkage connected to said at least one collar for enabling the discharge hose to move through a range of angles.

2. The low velocity pumping adapter as recited in claim 1, wherein the range of motion of the discharge hose is between approximately 0° and approximately 180° from vertical.

3. The low velocity pumping adapter as recited in claim 2, wherein the adapter preferably is capable of discharging concrete between approximately ⅛ ft.³/sec to approximately ¾ ft.³/sec.

4. The low velocity pumping adapter as recited in claim 1, wherein said adapter comprises at least a second collar, each of said at least two collars being connected to said linkage, said at least two collars contacting said discharge hose.

5. The low velocity pumping adapter as recited in claim 4, wherein said linkage comprises a chain.

6. The low velocity pumping adapter as recited in claim 5, wherein said chain has a securement means which is removably secured to at least one of said collars to adjust the angle of the discharge hose.

7. The low velocity pumping adapter as recited in claim 6, wherein said angle is between approximately 0° and approximately 180° from vertical.

8. The low velocity pumping adapter as recited in claim 4, wherein said linkage comprises a rigid or semi-rigid member.

9. The low velocity pumping adapter as recited in claim 4, wherein said adapter comprises at least yet another collar contacting said discharge hose, said yet another collar being connected to at least one other collar by a linkage.

10. The low velocity pumping adapter as recited in claim 9, wherein one of said collars is connected to at least two of said collars by rigid or semi-rigid members, and is interposed between at least two collars along the axis of the discharge hose.

11. The low velocity pumping adapter as recited in claim 10, wherein at least one of said collars has a handle.

12. A method for discharging concrete in a substantially splatter-free manner, comprising the steps of:
supporting the output end of a discharge hose by at least one collar of a pumping adapter;
forming a bend in the discharge hose by applying a force having at least a normal component to the collar, such that said bend aids in imparting a controlled, substantially splatter-free delivery.

13. The method for discharging concrete as recited in claim 12, wherein said bend formed by said forming step is between approximately 0° and approximately 180° from vertical.

14. The method for discharging concrete as recited in claim 13, wherein said force is applied by a linkage.

15. The method for discharging concrete as recited in claim 14, wherein said linkage is removably secured to at least one collar.

16. The method for discharging concrete as recited in claim 15, wherein said linkage is selected from the group consisting of a rigid or semi-rigid member, or chain or rope or cord, or combinations thereof.

17. The method for discharging concrete as recited in claim 16, comprising the further step of monitoring said delivery to determine whether said delivery is controlled and substantially splatter-free.

18. The method for discharging concrete as recited in claim 17, further comprising adjusting said linkage to form a different bend in the discharge hose to maintain a controlled, substantially splatter-free delivery.

19. The method for discharging concrete as recited in claim 18, wherein the concrete is preferably discharged between approximately ⅛ ft.³/sec to approximately ¾ ft.³/sec.
